(19) United States
(12) Patent Application Publication
(10) Pub. No.: US 2004/0236782 A1
(43) Pub. Date: Nov. 25, 2004

(54) Self-purging paper records filing system

(76) Inventor: Seth T. Odam, San Diego, CA (US)

Correspondence Address: Seth Odam, 635 "C" Street, 408, San Diego, CA, 92101, US

(21) Appl. No.: 10/440,212

(22) Filed: May 19, 2003

(51) Int. Cl. G06F 17/00

(52) U.S. Cl. 707/103 X

(57) ABSTRACT

A paper records filing system comprised of a multiplicity of pre-numbered and pre-categorized hanging file folders organized into three categories of documents: 1) documents for which a plurality of valid instances may exist at any given time, and for which each valid instance has an indeterminate useful life, 2) documents for which a single instance may exist at any given time, and for which each valid instance has an indeterminate useful life, and 3) documents for which a plurality of valid instances may exist at any given time, and for which each valid instance has a limited useful life. File folders are reused as new instances of documents are placed in pre-categorized hanging file folders replacing obsolete documents previously filed in the reused hanging file folder. Obsolete documents may become obsolete either because of the passage of time makes them obsolete or the generation of a new instance makes them obsolete. Hanging file folders are numbered and categorized depending on which in these events caused the documents contained therein to become obsolete.

### BACKGROUND

1. Field

This invention relates to a paper records filing and retrieval systems, specifically to such systems that employ file folders to categorize and separate multiple separate paper records.

2. Prior Art

The average person in today's world is practically inundated with paper records both in their home and at their workplace. Effectively categorizing and maintaining these records has become increasingly complex task, a task that, nonetheless, is crucial for effective management of one's affairs in the home and at work. This complexity is exacerbated by the fact that oftentimes documents have inherent longevity, after which a document is no longer necessary or relevant. For example, one need not keep receipts related to tax deductions beyond 3 years after a return is due. The statute of limitations for an audit expires and the necessity for proving the existence of the deductible expense passes. Likewise, documents may also exist with only one useful instance, for example a will. Only one will is valid, although one will may last for years. Previous incarnations are irrelevant and could create problems.

In the best case, keeping unnecessary documents can cause unnecessary storage expenses. In the worst case, relevant and timely documents may get lost, confused with the obsolete documents, or discarded when the entire system is overwhelmed.

In the home, for example, financial records including invoices for certain services and account statements form the basis from which individuals must prepare income tax returns. Likewise, individuals may have insurance policies, property deeds, medical information, etc., all of which must be categorized, stored, and made available to the individual. If all of these records are kept as they are generated, old receipts, outdated insurance policies, old leases, etc., will very quickly overwhelm a household.

In the workplace, paper flow management has become even more crucial. The volume of client files, interoffice memoranda, invoices, financial statements, board resolutions, etc., can quickly become unmanageable. Effective systems for maintaining and categorizing these paper records are therefore a necessity. Paper storage can become extremely costly, and the elimination of obsolete records may save business a significant amount of money. On the flip side, without proper control of the date and timing of the destruction of obsolete records, relevant and timely records may inadvertently be destroyed.

Unfortunately, most individuals have no training in these matters, either in business operation or household management. Many people are bewildered by the information to be taken in and organized, issues to be weighed, payments to be made, and the planning required to operate within a complex budget. As a result, errors in bank and financial statements go unchecked and unremediated, debt payments accumulate late charge penalties, interest rate return is not maximized, medical insurance reimbursements are not sought or fully paid, and the like. Likewise in a business setting, particularly a small business, income tax deductions may not be taken, or may be overstated; client records may be inadvertently destroyed; sensitive documents may be allowed to accumulate with public records; etc.

Several systems have been created to assist people in the effective management of paper records. Most involve color coding, creating predefined categories or physically separating documents into predefined spaces. Unfortunately, all of these approaches neglect a central problem: without regular maintenance filing systems becoming overwhelmed by obsolete or out of date documents. None of the prior art provides solutions for a never-ending, always growing collection of obsolete records. A review of literature in the area of file management reveals that common best practices revolve around creating a schedule for manually purging and maintaining file systems. For example, Barbara Hemphill, Taming the Paper Tiger, Kiplinger Books, 1998, p. 87, suggests that people create a “File Clean-Out Day.” Likewise, Dartmouth College Records Management Manual—8 Records Disposition 2002 http://www.dartmouth.edu/˜recmgmt/8Disposition/8Disposition.html#Archives advises creating a “Retention Schedule” and calendaring times to clear out documents that no longer need to be retained.

These systems are limited in that they require constant maintenance to function, which of course implicates human error, cost and time commitments. By contrast, the present invention automatically maintains the system and eliminates out of date and obsolete documents. In addition to the financial benefits to the invention, by creating a self-purging system the invention relieves the user of the constant and nagging worry over records maintenance.

Objects/Advantages

The object of the herein described invention resolves this problem and presents the following advantages:

a) to provide a paper filing system that automatically purges obsolete records;

b) to maintain a streamlined system of only relevant documents;

c) to avoid the necessity of periodic maintenance;

d) to avoid the necessity of storage space and expense related to obsolete documents;

e) to reduce the time and expense of retrieving relevant documents.

Still further objects and advantages will become apparent from a consideration of the ensuing description and drawings.

### SUMMARY

In accordance with the present invention, a filing system for paper records comprised of a series of hanging file folders labeled and categorized depending upon the inherent longevity of the records kept therein. New records replacing the obsolete records will be filed in the same folder as the now obsolete records. Records in “occupied” file folders will be removed and discarded.

### DRAWINGS

FIG. 1 is a prospective view of file system arranged in accordance with the present invention.

FIG. 2 is a prospective view file system showing the three major divisions with a multiplicity of hanging file folders in each division.

FIG. 3 is a functional block diagram of a possible embodiment of the first Division of documents being documents that accumulate without an inherent retention schedule.

FIG. 4 is a functional block diagram of a possible embodiment of the second Division of documents being those documents for which only one useful instance exists and is replaced by the next useful instance.

FIG. 5 is a functional block diagram of a possible embodiment of the third Division of documents being those documents for which a useful set accumulates and is replaced by the next useful set of instances.

FIG. 6 is a flowchart diagram which demonstrates a possible embodiment of the remove and replace process for documents in the second Division.

FIG. 7 is a flowchart diagram which demonstrates a possible embodiment of the remove and replace process for documents in the third Division.

FIG. 8 is a functional block diagram of an alternate embodiment of the third Division documents for which a useful set accumulates and is replaced by the next useful set of instances, specifically designed for the human resources department of a small business.

### DETAILED DESCRIPTION

Static

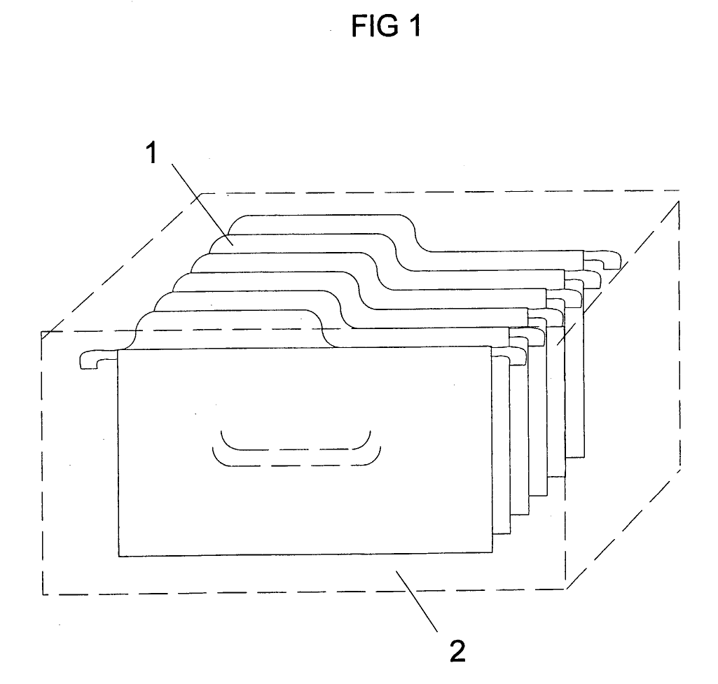

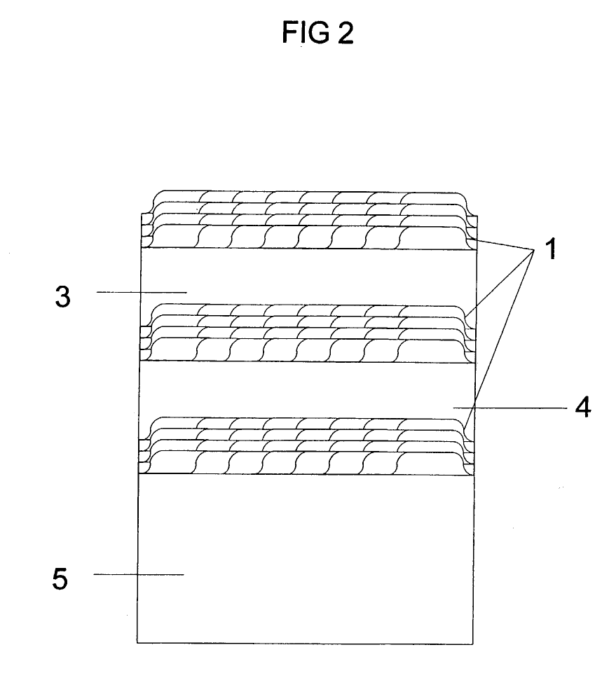

This invention comprises of a plurality of hanging file folders (1) hanging in a file box, drawer or cabinet (2) as seen in FIG. 1. Descriptions of hanging file folders, and the boxes, drawers and cabinets they are placed in, exist in a multiplicity of published sources and will not be duplicated herein. No advancement in the design of these objects is claimed in the present invention. The hanging file folders (1) are divided into three categories: documents that accumulate without an inherent retention schedule (3) (hereinafter referred to as “PERMANENT RECORDS”), documents for which only one useful instance exists and is replaced by the next useful instance (4) (hereinafter referred to as “REMOVE AND REPLACE RECORDS”), and documents for which a useful set accumulates until time or a specific event makes the set obsolete (5) (hereinafter referred to as “ROTATING RECORDS”). FIG. 2. The useful life of a set may extend beyond the date the set closes and is no longer being added to. Additional useful sets within a category of documents may be generated during the useful life of a previous set.

With the exception of PERMANENT RECORDS, a fixed number of hanging file folders are created for each category of documents within each Division. Nothing herein should be construed to limit the number of categories the user can create within each Division. For REMOVE AND REPLACE RECORDS, a single file folder will be created per category of document. For example, the current registration for a particular vehicle is useful until replaced by a new, current year registration. A single file folder would be created to hold the current registration for that particular vehicle. For ROTATING RECORDS, a fixed number of folders would be created per category of documents. The number of folders created per category will be determined by the number of useful sets within a category generated during the useful life of a set. Nothing herein should be construed to limit the number of divisions within a set the user can create to organize the documents. For example, if one were keeping phone bills to prepare a tax return, one might need to keep a full year's worth of bills. These bills would form one useful set. One may wish to keep this set of phone bills four years beyond the year they were generated in to have available in case of an audit. During the time the set of phone bills is kept, four more similar sets will be generated. Therefore, at least five folders must be created. Of course, a user may wish to divide the set by month, for example, for ease of document retrieval. For PERMANENT RECORDS, only, file folders are added to each category with the passage of time to accommodate the accumulating records.

As described in more detail below, the system is purged at the time new documents are generated and old documents are made obsolete by re-using the fixed number of file folders. The efficient purging is made possible by determining beforehand how and when documents are made obsolete by subsequent documents and whether useful documents accumulate in sets or exist as single useful instances. Once a document is so categorized, the size of the filing system can be pre-determined allowing for a cycling through of useful documents. Hanging file folders are added to the system only in the number needed to hold useful documents. Obsolete documents “loose their place” and are discarded to make room for new documents.

In the preferred embodiment, each of the main divisions of documents shall be indicated by associating each of the hanging file folders within the Division with a particular color, tab color, location or text, as chosen by the user. For example, in the application shown in FIGS. 1-7, a common household filing system, each hanging file folder within PERMANENT RECORDS would be constructed out of red paperboard (3); each hanging file folder within REMOVE AND REPLACE RECORDS would be constructed out of blue paperboard (4); and each hanging file folder within the ROTATING RECORDS would be constructed out of green paperboard (5). Each main Division may be subdivided into any number of subdivisions (7), provided however that a single instance of a document belonging to a single bottom level category will be kept in a single file folder. Within ROTATING RECORDS, sets of documents from the same category may be grouped or intermixed with other categories and grouped by date (8). All subdivisions and document categories shall be of the user's choosing depending on the user's need. Each subdivision or category may be further divided per the user's need until sufficient categories exist to serve the user's needs.

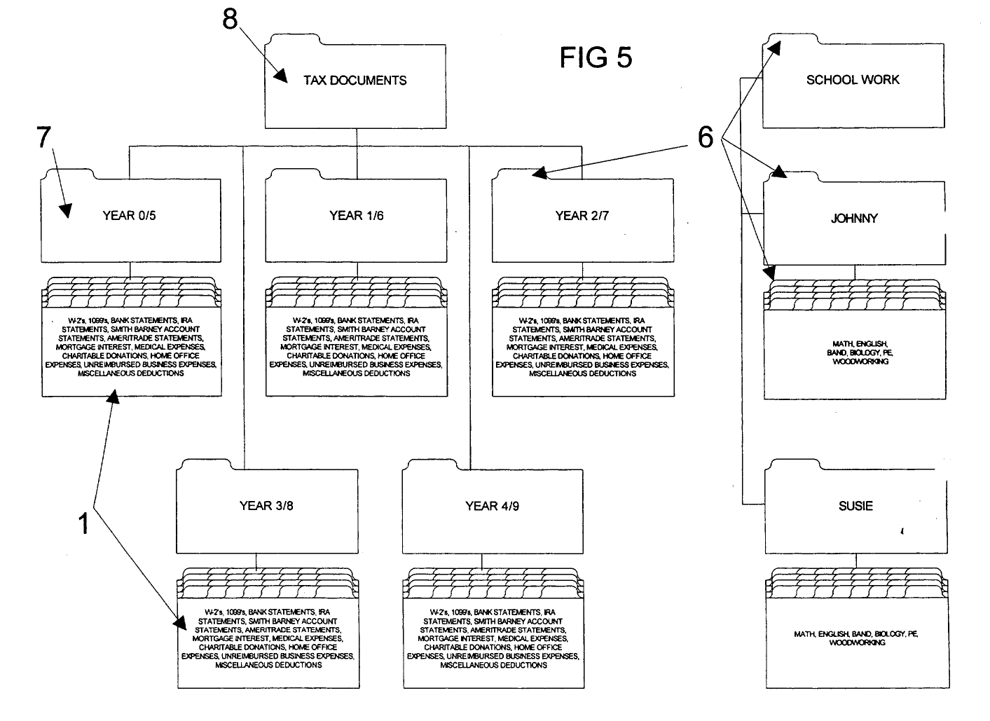

For example, in FIG. 5 ROTATING RECORDS has been subdivided into documents used for tax preparation, which may have a useful life to the user of the current year plus three years (the statute of limitations for a tax audit), and documents relating to children's schoolwork, which may have a useful life of a single school year.¹ Therefore, the first level subdivision (8) is a subdivision of documents with different retention schedules. Tax documents are separated from schoolwork because they have different inherent retention schedules. Within the tax documents subdivision the user has created a further subdivision by year and a further subdivision by tax category. Likewise, in the “schoolwork” subdivision a further subdivision by child's name has been created and within that subdivisions by individual classes. ¹ Longevity is determined by the user's needs. While three years plus the current year is useful guide for most users, some may wish to keep tax records longer or not as long.

Subdivisions may be indicated by the color of the tab on the folder, the color of the ink printed on the tab, by use of a second tab, or any combination thereof. Color classifications may be carried through multiple divisions. For example documents relating to a single spouse in a two spouse household may always have red ink on the tabs regardless of whether the record is a PERMANENT RECORD, REMOVE AND REPLACE RECORD, or ROTATING RECORD.

The bottom level subdivision of each Division shall consist of an individual hanging file folder. (1) The category of documents to be placed within a particular hanging file folder shall be indicated by a printed tab placed on the top edge of the far fold of the hanging file folder. (6) For example, the bottom level subdivision within ROTATING RECORDS, subdivision “schoolwork”, subdivision “Johnny,” would be an individual hanging file folder labeled “English class.” The set of documents that comprises the current year's English class category, e.g. grades, tests, parent/teacher meetings, etc., would be placed in this bottom level category's folder.

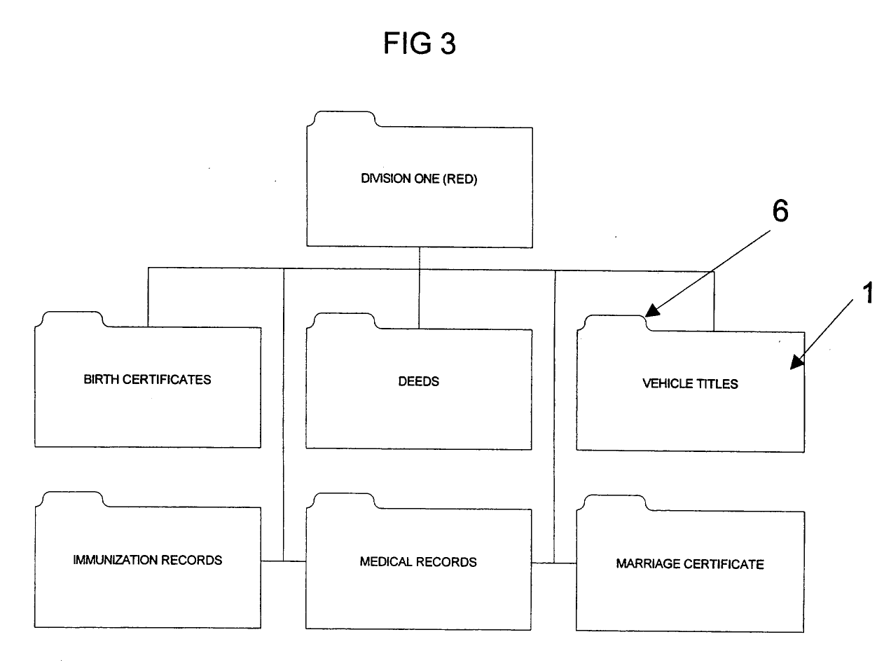

With regard to FIG. 3, depicting PERMANENT RECORDS, a plurality of file folders are depicted with no subdivision below the top-level first Division indicated by the color of the hanging file folder. Each file folder (1) is labeled with a printed tab (6) indicating the category and documents contained therein. For example, each hanging file folder is depicted showing a description such as, BIRTH CERTIFICATES, DEEDS, VEHICLE TITLES, IMMUNIZATION RECORDS, MARRIAGE CERTIFICATE. Records placed in the folders are kept indefinitely and new folders are added as needed.

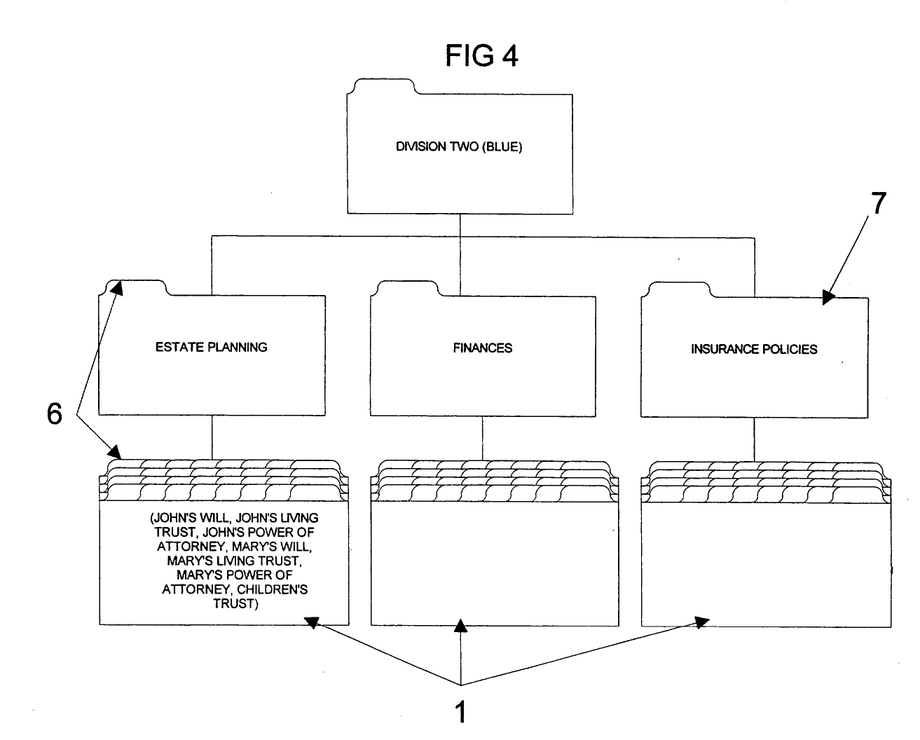

With regard to FIG. 4, depicting REMOVE AND REPLACE DOCUMENTS, a plurality of file folders are depicted subdivided by the following categories: ESTATE PLANNING, FINANCES, LICENSES AND REGISTRATIONS, INSURANCE POLICIES. Hanging paperboard dividers (7) with preprinted tabs (6) of specified color indicate the subdivisions. In this embodiment, for example, ESTATE PLANNING divider is printed black ink upon a gray tab. A plurality of hanging file folders (1) are shown within the ESTATE PLANNING subdivision labeled as follows: JOHN'S WILL, JOHN'S LIVING TRUST, JOHN'S POWER OF ATTORNEY, MARY'S WILL, MARY'S LIVING TRUST, MARY'S POWER OF ATTORNEY, CHILDREN'S TRUST. Individual file folder tabs within this subdivision are likewise printed black ink upon a gray field. (6) A single hanging file folder exists for each bottom level category, and a single record is filed within. New records replace old records in the already existing file folder. For example, when a revised will replaces an obsolete will, the new will is filed in the same file folder the old will was filed in. The old will is discarded to make room for the new will.

With regard to FIG. 5, ROTATING DOCUMENTS, a plurality of file folders are depicted subdivided into two principal categories: TAX DOCUMENTS, SCHOOLWORK. (8) Hanging paperboard dividers with preprinted tabs indicate the top-level Division. (8) Within the subdivision TAX DOCUMENTS, hanging paperboard dividers (7) with preprinted tabs (6) of specified color indicate a further subdivision into calendar years as follows: YEAR 0/5, YEAR 1/6, YEAR 2/7, YEAR 3/8, YEAR 4/9. Within each YEAR subdivision, a multiplicity of hanging file folders (1) are labeled (6) with tax categories as follows: W-2's, 1099's, BANK STATEMENTS, IRA STATEMENTS, SMITH BARNEY ACCOUNT STATEMENTS, AMERITRADE STATEMENTS, MORTGAGE INTEREST, MEDICAL EXPENSES, CHARITABLE DONATIONS, HOME OFFICE EXPENSES, UNREIMBURSED BUSINESS EXPENSES, MISCELLANEOUS DEDUCTIONS. There are thereby exactly 5 hanging file folders of each bottom-level category. These folders are used sequentially, one per year, until all are filled. Upon the sixth year, newly generated documents will replace older documents in the same hanging file folder, thereby purging each folder once per 5-year period.

Within the subdivision SCHOOLWORK, (8) hanging paperboard dividers with preprinted tabs of specified color indicate for which child the documents contained therein relate. (7) They are labeled: JOHNNY, SUSIE. Within each subdivision individual hanging file folders (1) are labeled (6) for each class a child is taking that year. For example, within the JOHNNY subdivision individual hanging file folders (1) are labeled (6): MATH, ENGLISH, BAND, BIOLOGY, PE, WOODWORKING.

Operation

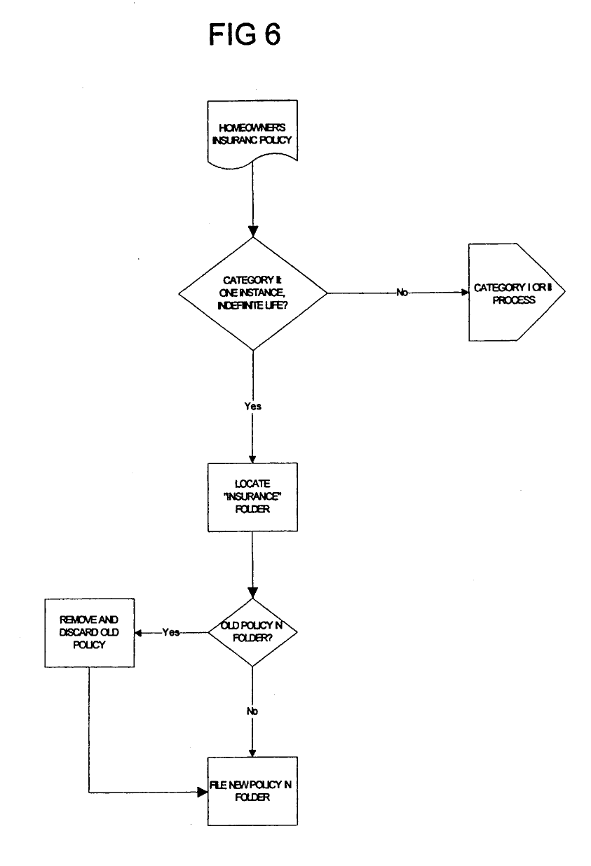

With regard to FIG. 6, a flowchart is depicted showing the flow of an individual record through the system. It shows a particular document, in this case and updated copy of a homeowner's insurance policy. A homeowner's insurance policy may be of the category REMOVE AND REPLACE RECORDS within the user's system. The flowchart depicts the user identifying the general subdivision, INSURANCE POLICIES, and within that subdivision finding the hanging file folder labeled HOMEOWNER'S POLICY. The user will then remove the existing copy from the hanging file folder, place the updated copy into the folder, and discard the now outdated copy.

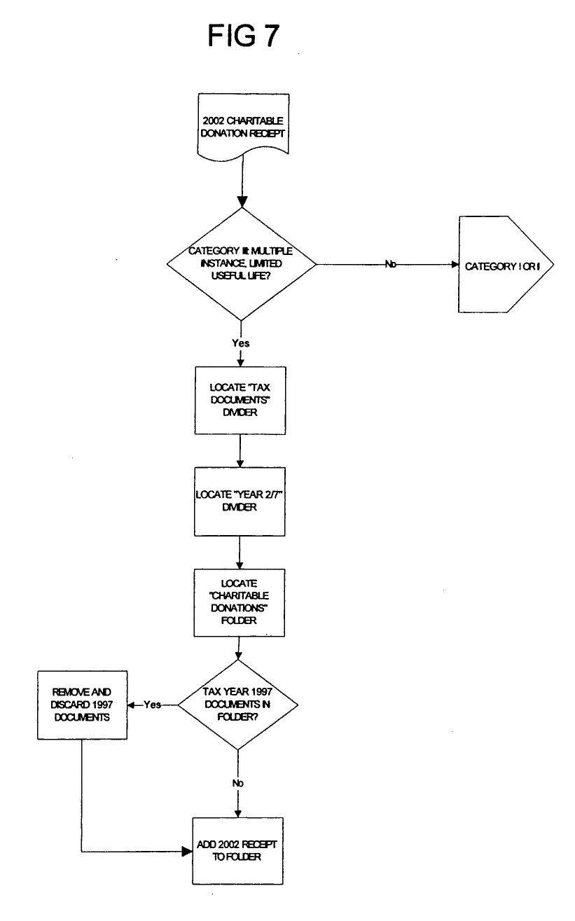

With regard to FIG. 7, a flowchart is depicted showing the flow of an individual record through the system. It shows a particular document, in this case a receipt from a charitable donation made in the 2002 tax year. A charitable donation is of the category ROTATING DOCUMENTS (a set comprising of all charitable donation receipts for a given tax year accumulate, are kept a fixed number of years and then become obsolete with the generation of new receipts). The flowchart depicts the user identifying the first subdivision of TAX DOCUMENTS, and within that the subdivision corresponding to the year 2002, “YEAR 2/7”. Within the YEAR subdivision, the user locates the file folder labeled CHARITABLE DONATIONS and finds documents already filed there from 1997. The user removes the now obsolete 1997 documents and places the charitable donation receipt for 2002 in the folder. The user then discards the 1997 documents.

Alternate Embodiments

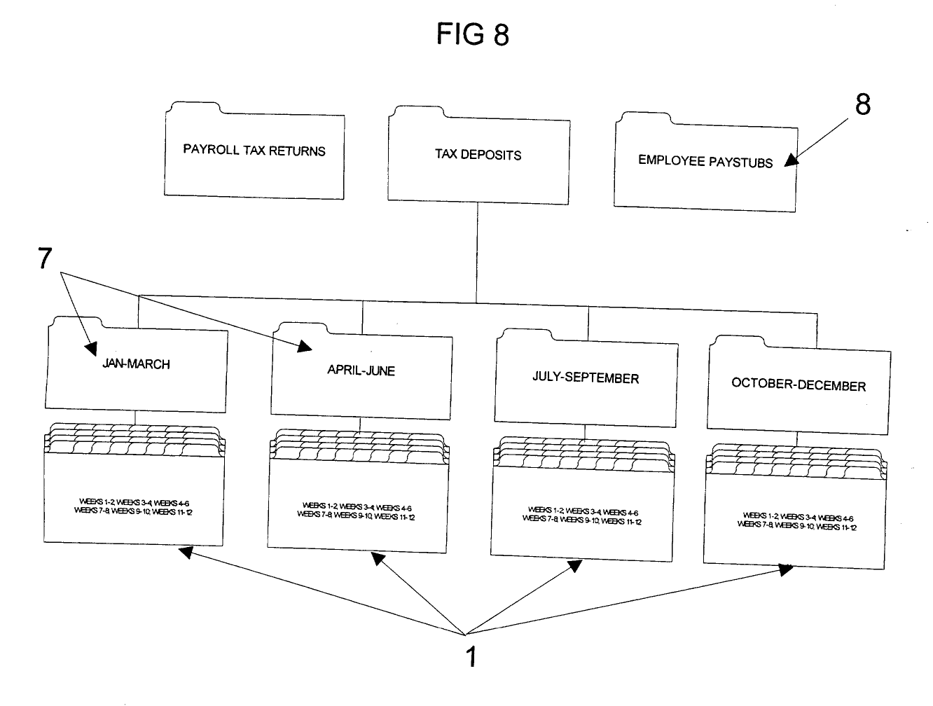

With regard to FIG. 8, depicting Division Three, ROTATING DOCUEMNTS, of the system as applied to the human resources department of a small business, a plurality of file folders (1) are depicted subdivided into three separate categories: TAX DEPOSITS, PAYROLL TAX RETURNS, EMPLOYEE PAY STUBS (8). TAX DEPOSITS are further subdivided into calendar quarters as follows: JANUARY-MARCH, APRIL-JUNE, JULY-SEPTEMBER, OCTOBER-DECEMBER (7) to permit an employer to prepare quarterly and annual returns. Each quarterly subdivision is further divided into semiweekly folders (1) for each period a tax deposit is generated. The tax deposit record for the first semiweekly period of January of the current year will replace the deposit record for the same period of time from the previous year. The previous year's document is now obsolete because the quarterly return for that year has already been prepared and filed, and can therefore be discarded.

### CONCLUSION

This invention provides a system for dealing with the removal of irrelevant or outdated documents from a filing system to facilitate efficient retrieval of relevant documents, minimize cost of storage, and eliminate the need for periodic maintenance of a filing system. By providing a system of classification and storage divided into sufficient units to accommodate the frequency that a particular category of document is generated within its useful life span, its longevity, and the number of useful instances which can exist at any given time, and reusing the classification and storage units as the documents become obsolete, file system maintenance can be eliminated and filing systems can be streamlined. Previous systems of pre-prepared and pre-classified filing failed to provide for advanced file system maintenance. This invention solves that problem.

I claim:

1) A method of automatic purging of obsolete paper records in a filing system comprising of:
a) categorizing documents based on their inherent longevity and the number of valid concurrent instances that may exist for each category of documents, and
b) providing a finite series of pre-classified file folders corresponding to the said categories into which documents are inserted, and
c) reusing said file folders by replacing obsolete documents within the file folders as current documents are generated with current documents.

2) The filing system of claim 1, comprising of:
a) a first plurality of hanging file folders of paperboard construction to receive documents of which multiple valid concurrent instances may exist and which have undefined inherent useful life, and
b) a second plurality of hanging file folders of paperboard construction to receive documents of which a single valid concurrent instance may exist and which have undefined inherent useful life, and
c) a third plurality of hanging file folders of paperboard to receive documents of which multiple valid concurrent instances may exist and which have a defined inherent useful life.

3) The filing system of claim 2, including an unlimited number of hanging file folders labeled by category of records to receive permanent records.

4) The filing system of claim 2, including a limited number of hanging file folders labeled by category of records comprising of a single folder per category to receive documents that must be discarded and replaced by newer versions as those versions are created.

5) The filing system of claim 2, including a limited number of hanging file folders labeled by category of records comprising a fixed number of folders per category to receive documents that accumulate over a period of time and must be rotated out of the filing system when no longer useful.

6) The filing system of claim 2, including a means comprising of hanging paperboard dividers of the same paperboard construction and color as the said hanging file folders for subdividing the plurality of file folders.

7) The filing system of claim 2, including a means comprising of colored tabs of subdividing the plurality of file folders.

8) The filing system of claim 2, including a means comprising of different colored ink on pre-printed tabs to indicate the subdivision of the plurality of file folders.

9) The filing system of claim 2, including a means comprising of a combination of colored tabs, colored ink on pre-printed tabs, and hanging paperboard dividers of the same paperboard construction and color as the said hanging file folders of subdividing the plurality of file folders.
